(19) United States
(12) Patent Application Publication
(10) Pub. No.: US 2008/0158649 A1
(43) Pub. Date: Jul. 3, 2008

(54) OPTICAL MODULATOR MODULE PACKAGE

(75) Inventors: Heung-Woo Park, Suwon-si (KR); Tae-Won Lee, Seoul (KR); Sang-Kyeong Yun, Suwon-si (KR); Chang-Su Park, Suwon-si (KR); Victor Yurlov, Suwon-si (KR); Jong-Hyeong Song, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/957,107

(22) Filed: Dec. 14, 2007

(30) Foreign Application Priority Data
Dec. 27, 2006 (KR) 10-2006-0135133

(51) Int. Cl. G02B 26/02

(52) U.S. Cl. 359/291

(57) ABSTRACT

The present invention relates to a MEMS package, more specifically to an optical module package. According to an aspect of the present invention, the optical modulator module package includes an optical modulator, emitting a beam of light, which is modulated by diffracting and interfering the beam of light by an upwardly and downwardly spaced distance of a mirror, the beam of light being incident from a light source; a driver IC, mounted on the surrounding of the optical modulator to drive the optical modulator; and a noise removing member, intercepting a beam of light, which is not incident to a mirror area of the light modulator, of the incident beams of light.

This application claims the benefit of Korean Patent Application No. 10-2006-0135133, filed on Dec. 27, 2006, in the Korean Intellectual Property Office, the disclosure of which is incorporated herein in its entirety by reference.

### BACKGROUND OF THE INVENTION

1. Field of the Invention

The present invention relates to a MEMS package, more specifically to an optical module package.

2. Background Art

An optical modulator refers to a (optical modulating) circuit or apparatus loading a signal in the light in a transmitter in the case of using optical fibers or a free space of an optical frequency band as a transmission medium. The optical modulator is used for various fields such as optical memory, optical display, printer, optical interconnection and hologram. Currently, studies on display apparatuses using the optical modulator are actively in progress. This optical modulator is related to a micro electro mechanical system (MEMS) technology. The MEMS the technology forms a 3-dimensional structural layer on a silicon substrate by using semiconductor manufacturing technologies.

The MEMS has a variety of applicable fields, for example, various kinds of sensors for vehicles, ink jet printer heads, HDD magnetic heads and portable communication apparatuses having compact-size and high-functions. In a MEMS device, there is provided a part suspended in a substrate in order to make it possible to be minutely operated on the substrate for a machinery operation. The MEMS, which is alternatively referred as a micro electro mechanical device, is being used for an optical science. If the MEMS technologies, is used, not only optical devices having a smaller size than 1 mm can be manufactured but also micro optical systems can be realized by using the optical devices.

The micro optical system is employed and applied in information communication apparatuses, information displays and recording apparatuses, due to its quick response, little loss, and integration and digital capabilities. For example, micro optical parts, such as micro-mirrors, micro-lenses and optical fiber holders, can be applied to a data storage device, a large display device, an optical communication device and adaptive optics

Here, the micro-mirror is variously applied according to directions, such as upward and downward, and static and dynamic movements. The movement in upward and downward directions is applied for a phase corrector or a diffractor. The movement in an inclining direction is applied for a scanner, a switch, an optical signal distributor, an optical attenuator and an optical array. The movement in a sliding direction is applied for an optical isolator, a switch and an optical distributor.

The number and size of micro-mirrors are varied depending on the applied apparatuses or devices. The applications depend on the operating direction and the static or dynamic operation. Of course, the method of manufacturing the micro-mirror is also dependent on the applications.

At this time, there has occurred the problem that light incident to the micro-mirror and light reflected by a surrounding wiring area for supplying a signal to the micro-mirror or a driving unit for driving the micro-mirror, met each other, create diffraction and interference. In other words, light modulated according to an inputted signal in an optical modulator is not reflected in a mirror area of the optical modulator but is diffracted and interfered with by light reflected in the surroundings of the mirror, to thereby distort an image emitted to on a screen.

### SUMMARY OF THE INVENTION

The present invention provides an optical modulator module package that can minimize an effect that a beam of light, not reflected in a mirror area of an optical modulator, of beams of light emitted from a light source has on a modulated beam of light emitted from the optical modulator.

The present invention also provides an optical modulator module package that can remove the noise of an optical modulator by intercepting a beam of light, not incident to an optical modulator.

In addition, the present invention provides an optical modulator module package that can remove the noise of an optical modulator by diffused reflecting a beam of light, not incident to an optical modulator.

Other problems that the present invention solves will become more apparent through the following description.

According to an aspect of the present invention, there can be provided an optical modulator module package, including an optical modulator, emitting a beam of light, which is modulated by diffracting and interfering the beam of light by an upwardly and downwardly spaced distance of a mirror, the beam of light being incident from a light source; a driver IC, mounted on the surrounding of the optical modulator to drive the optical modulator; and a noise removing member, intercepting a beam of light, which is not incident to a mirror area of the light modulator, of the incident beams of light.

Here, the noise removing member can be a material, absorbing the beam of light, which is not incident to the mirror area of the light modulator, of the incident beams of light.

Further, the noise removing member can be configured to diffusedly reflect the beam of light, which is not incident to the mirror area of the light modulator, of the incident beams of light.

According to another aspect of the present invention, there can be provided an optical modulator module package, including a lower board, on which a circuit line is formed; an optical modulator, located in a surface of the lower board and modulating an incident beam of light and penetrating the modulated beam of light through the lower board; a driver IC, mounted on the surrounding of the optical modulator to receive a signal for driving the optical modulator through the circuit line formed on the lower board and to drive the optical modulator; and a bending member, formed on the lower board and reflecting some of the incident beams of light in a different direction from an advancing direction of the modulated beams of light.

The optical modulator module package can further include a printed circuit board, located on the optical modulator and the driver IC, facing the lower board, and performing a signal connecting function with an external circuit.

Here, the lower board can include a transparent area, corresponding to the optical modulator, capable of light penetration.

The bending member can be also made of a plurality of reflecting materials having triangle-shaped sections.

The angle, which is formed by a line, different from a line tangent to the lower board, of the triangle-shaped sections of the plurality of reflecting materials and a normal line of the lower board, can be between 0 and 45 degree.

The bending member can be formed on a surface of the lower board, in which the optical modulator is located, or on another surface.

In addition, the bending member can be a film, a surface of which a plurality of reflecting materials, having triangle-shaped sections, is formed on.

According to another aspect of the present invention, there can be provided an optical modulator module package, including a lower board, on which a circuit line is formed; an optical modulator, located in a surface of the lower board and modulating an incident beam of light and penetrating the modulated beam of light through the lower board; a driver IC, mounted on the surrounding of the optical modulator to receive a signal for driving the optical modulator through the circuit line formed on the lower board and drive the optical modulator; and a light absorbing member, formed on the lower board and absorbing a beam of light, which is not incident to the light modulator, of the incident beams of light.

Here, the light absorbing member can be made of chrome or chrome oxide.

The optical modulator module package of the present invention can further include a printed circuit board, located on the optical modulator and the driver IC, facing the lower board, and performing a signal connecting function with an external circuit.

Here, the lower board can include a transparent area, corresponding to the optical modulator, capable of light penetration.

Further, the bending member can be formed on a surface of the lower board, in which the optical modulator is located, or on another surface.

According to another aspect of the present invention, there can be provided an optical modulator module package, including a lower board, on which a circuit line is formed; an optical modulator, located in a surface of the lower board and modulating an incident beam of light and penetrating the modulated beam of light through the lower board; and a driver IC, mounted on the surrounding of the optical modulator to receive a signal for driving the optical modulator through the circuit line formed on the lower board and drive the optical modulator, whereas a roughness, reflecting a beam of light, which is not incident to the light modulator, of the incident beams of light in a different direction from an advancing direction of the modulated beam of light, can be formed on a surface of the lower board.

Here, the roughness is formed by a sanding process.

The roughness can be also formed by laser-etching a metal coated on the lower board.

The optical modulator module package can further include a printed circuit board, located on the optical modulator and the driver IC, facing the lower board, and performing a signal connecting function with an external circuit.

Here, the lower board comprises a transparent area, corresponding to the optical modulator, capable of light penetration.

### BRIEF DESCRIPTION OF THE DRAWINGS

These and other features, aspects and advantages of the present invention will become better understood with regard to the following description, appended claims and accompanying drawings where:

FIG. 1A is a perspective view showing a type of a diffractive optical modulator module using a piezoelectric element applicable to an embodiment of the present invention;

FIG. 1B is a perspective view showing another form of a diffractive optical modulator module using a piezoelectric element applicable to an embodiment of the present invention;

FIG. 1C is a plan view showing a diffractive optical modulator array applicable to an embodiment of the present invention;

FIG. 1D is a schematic view of a screen generated with an image by a diffractive optical modulator array applicable to an embodiment of the present invention;

FIG. 2A is an exploded perspective view showing an optical modulator module package in accordance with an embodiment of the present invention;

FIG. 2B is a schematic view of a mobile display apparatus using an optical modulator and a scanner in accordance with an embodiment of the present invention;

FIG. 3 illustrates a light path of an optical modulator package in accordance with a first embodiment of the present invention;

FIG. 4 illustrates a light path of an optical modulator package in accordance with a second embodiment of the present invention;

FIG. 5 illustrates a structure of diffused reflection of an optical modulator package in accordance with a first embodiment of the present invention;

FIG. 6 is an example illustrating an angle of reflection depending on a different angle of an optical modulator package in accordance with a first embodiment of the present invention;

FIG. 7A and FIG. 7B illustrate a light path of an optical modulator package in accordance with a third embodiment of the present invention; and

FIG. 8 illustrates a light path of an optical modulator package in accordance with a fourth embodiment of the present invention.

### DESCRIPTION OF THE EMBODIMENTS

Hereinafter, some embodiments of an optical modulator module package in accordance with the present invention will be described in detail with reference to the accompanying drawings. Identical or corresponding elements will be given the same reference numerals, regardless of the figure number, and any redundant description of the identical or corresponding elements will not be repeated. Throughout the description of the present invention, when describing a certain technology is determined to evade the point of the present invention, the pertinent detailed description will be omitted. Also, the embodiment of the present invention can be applied to a MEMS package typically for transmitting a signal to the outside or receiving a signal from the outside. Before the detailed description related to the embodiment of the present invention, a spatial optical modulator, among the MEMS package applied by the present invention, will be firstly described.

The spatial optical modulator is mainly divided into a direct type, which directly controls the on/off state of light, and an indirect type, which uses reflection and diffraction. The indirect type can be further divided into an electrostatic type and a piezoelectric type. Here, the spatial optical modulator is applicable to the present invention regardless of the operation type.

An electrostatic type grating optical modulator includes a plurality of regularly spaced reflective ribbons having reflective surfaces and suspended above an upper part of the substrate, the spaced distances of the reflective ribbons being adjustable.

First, an insulation layer is deposited onto a silicon substrate, followed by depositions of a silicon dioxide film and a silicon nitride film. Here, the silicon nitride film is patterned with the ribbons, and some portions of the silicon dioxide film are etched such that the ribbons can be maintained by a nitride frame on an oxide spacer layer. The ribbon and the oxide spacer of the spatial optical modulator are designed to have a thickness of λ₀/4 in order to modulate a light beam having a single wavelength λ₀.

The grating amplitude, of the modulator limited to the vertical distance d between the reflective surfaces of the ribbons and the reflective surface of the substrate, is controlled by supplying a voltage between the ribbons (the reflective surface of the ribbon, which acts as a first electrode) and the substrate (the conductive film at the bottom portion of the substrate, which acts as a second electrode).

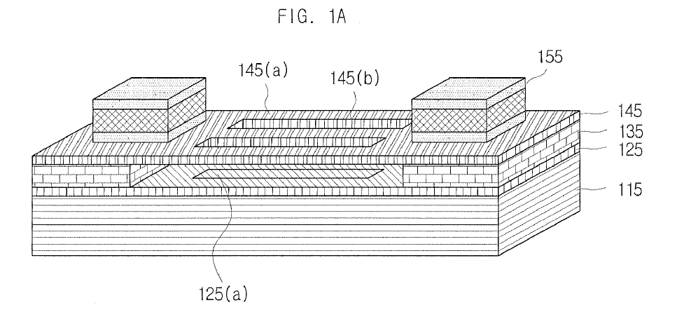

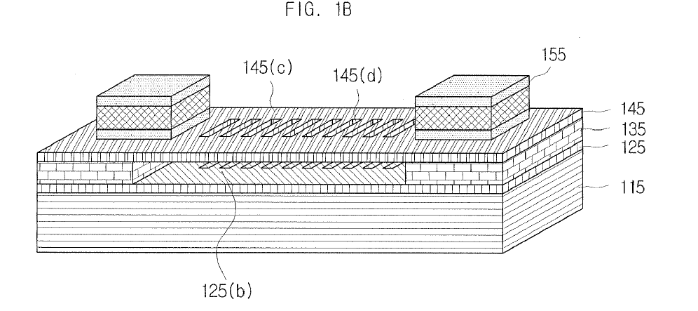

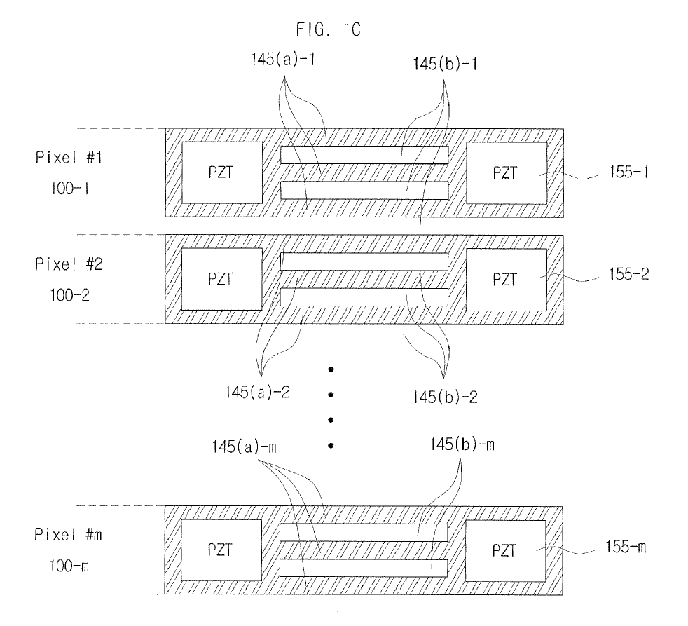

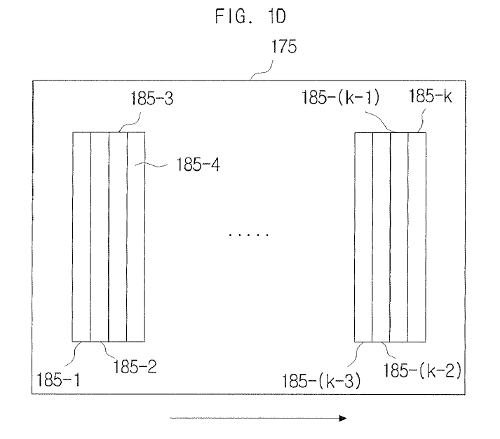

FIG. 1A is a perspective view showing a type of a diffractive optical modulator module using a piezoelectric element applicable to an embodiment of the present invention, and FIG. 1B is a perspective view showing another form of a diffractive optical modulator module using a piezoelectric element applicable to an embodiment of the present invention. Referring to FIG. 1A and FIG. 1B, the optical modulating device including a substrate 115, an insulation layer 125, a sacrificial layer 135, a ribbon structure 145 and a piezoelectric element 155 are illustrated. Here, the piezoelectric element 155 can be typically used as one of driving means.

The substrate 115 is a commonly used semiconductor substrate, and the insulation layer 125 is deposited as an etch stop layer. The insulation layer 125 is formed from a material with a high selectivity to the etchant (an etching gas or an etching solution) that etches the material used as the sacrificial layer 135. Here, a lower reflective layer 125(a) or 125(b) can be formed on the insulation layer 125 to reflect incident beams of light.

The sacrificial layer 135 supports the ribbon structure 145 at opposite sides such that the ribbon structure 145 can be spaced by a constant gap from the insulation layer 125, and forms a space in the center part.

The ribbon structure 145, as described above, creates diffraction and interference in the incident light to perform optical modulation of signals. The form of the ribbon structure 145, as described above, can be configured in a plurality of ribbon shapes in the electrostatic type, or can include a plurality of open holes in the center portion of the ribbons in the piezoelectric type. Also, the piezoelectric element 155 controls the ribbon structure 145 to move upwardly and downwardly according to upward and downward, or leftward and rightward contraction or expansion levels generated by the difference in voltage between the upper and lower electrodes. Here, the lower reflective layer 125(a) or 125(b) is formed in correspondence with the holes 145(b) or 145(d) formed in the ribbon structure 145.

For example, in case that the wavelength of a beam of light is λ, when there is no power supplied or when there is a predetermined amount of power supplied, the gap between an upper reflective layer 145(a) or 145(c), formed on the ribbon structure 145, and the insulation layer 125, formed with the lower reflective layer 125(a) or 125(b), is equal to nλ/2, n being a natural number. Accordingly, in the case of a 0^{th}-order diffracted (reflected) beam of light, the overall path length difference between the light reflected by the upper reflective layer 145(a) or 145(c) formed on the ribbon structure 145 and the light reflected by the insulation layer 125 is equal to nλ, so that constructive interference occurs and the diffracted light renders its maximum luminance. In the case of the +1^{st} or −1^{st} order diffracted light, however, the luminance of the light is at its minimum value due to destructive interference.

Also, when a predetermined amount of power, which is different from the supplied power mentioned above, is supplied to the piezoelectric elements 155, the gap between the upper reflective layer 145(a) or 145(c) formed on the ribbon structure 145 and the insulation layer 125, formed with the lower reflective layer 125(a) or 125(b), becomes (2n+1)λ/4, n being a natural number. Accordingly, in the case of a 0^{th}-order diffracted (reflected) beam of light, the overall path length difference between the light reflected by the upper reflective layer 145(a) or 145(c) formed on the ribbon structure 145 and the light reflected by the insulation layer 125 is equal to (2n+1)λ/2, so that destructive interference occurs, and the diffracted light renders its minimum luminance. In the case of the +1^{st} or −1^{st} order diffracted light, however, the luminance of the light is at its maximum value due to constructive interference. As a result of such interference, the spatial optical modulator can load signals on the beams of light by adjusting the quantity of the reflected or diffracted light.

Although the foregoing describes the cases in which the gap between the ribbon structure 145 and the insulation layer 125 formed with the lower reflective layer 125(a) or 125(b), is nλ/2 or (2n+1)λ/4, it is obvious that a variety of embodiments, which are able to operate with a gap adjusting the intensity of interference by diffraction and reflection of the incident light, can be applied to the present invention.

The below description will focus on a spatial optical modulator illustrated in FIG. 1A and described above.

Referring to FIG. 1C, the spatial optical modulator is configured to include m micro-mirrors 100-1, 100-2, . . . , and 100-m, each of which corresponds to a first pixel (pixel #1), a second pixel (pixel #2), . . . , and an m^{th} pixel (pixel #m), respectively, m being a natural number. The spatial optical modulator deals with image information with respect to 1-dimensional images of vertical or horizontal scanning lines (which are assumed to consist of m pixels), while each micro-mirror 100 deals with one pixel among the m pixels constituting the vertical or horizontal scanning line. Thus, the light reflected or diffracted by each micro-mirror is later projected as a 2-dimensional image to a screen by an optical scanning device. For example, in the case of an image having a VGA resolution of 640*480, modulation is performed 640 times for one surface of the optical scanning device for 480 vertical pixels, to thereby generate 1 frame of display per surface of the optical scanning device. Here, the optical scanning device can be a polygon mirror, a rotating bar, or a Galvano mirror, for example.

While the description below of the principle of optical modulation concentrates on the first pixel (pixel #1), the same can obviously apply to other pixels.

In the present embodiment, it is assumed that the number of holes 145(b)-1 formed in the ribbon structure 145 is two. Because of the two holes 145(b)-1, there are three upper reflective layers 145(a)-1, operated by a piezoelectric element 155-1, formed on an upper part of the ribbon structure 145. On the insulation layer 125, two lower reflective layers are formed in correspondence with the two holes 145(b)-1. Also, there is another lower reflective layer formed on the insulation layer 125 in correspondence with the gap between the first pixel (pixel #1) and the second pixel (pixel #2). Accordingly, the number of the upper reflective layers 145(a)-1 is identical to that of the lower reflective layers per pixel, and as discussed with reference to FIG. 1A, it is possible to control the luminance of the modulated light by using the 0^{th}-order diffracted light or ±1^{st}-order diffracted light.

FIG. 1D is a schematic view showing a screen generated with an image by a diffractive optical modulator array applicable to an embodiment of the present invention.

Lights reflected and/or diffracted by vertically arranged m micro-mirrors 100-1, 100-2, . . . , and 100-m are reflected by the optical scanning device and then scanned horizontally onto a screen 175, to thereby generate pictures 185-1, 185-2, 185-3, 185-4, . . . 185-(k-3), 185-(k-2), 185-(k-1), and 185-k. One image frame can be projected in the case of one rotation of the optical scanning device. Here, although the scanning is performed from the left to the right (the arrow indicating the direction), it is apparent that images can be scanned in another direction (e.g. in the opposite direction).

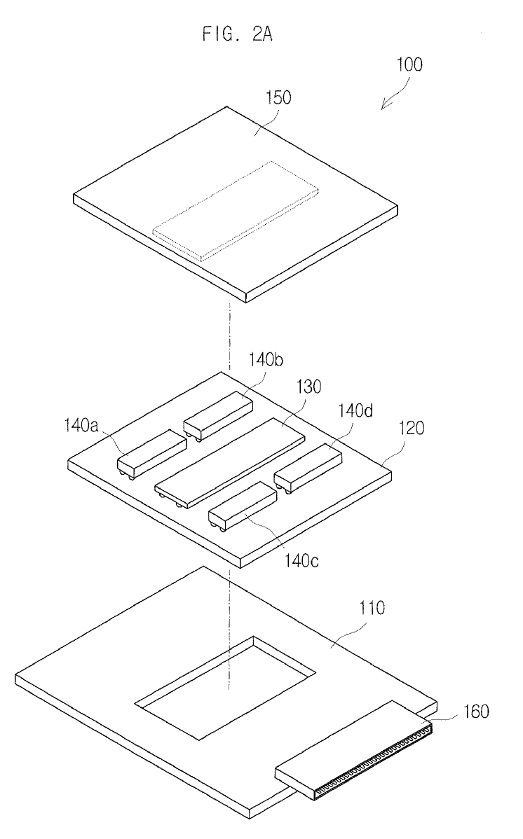

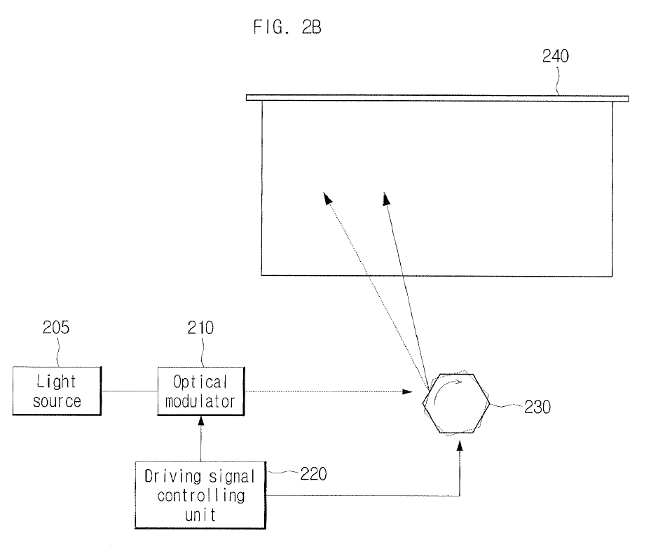

FIG. 2A is an exploded perspective view showing an optical modulator module package in accordance with an embodiment of the present invention. Referring to FIG. 2A, the optical modulator module package 100 includes a printed circuit board 110, a light transmission board 120, an optical modulator 130, a driver IC (integrated circuit) 140a through 140d, a heat spreader 150 and a connector 160.

The printed circuit board 110 is a typically used printed circuit board for a semiconductor package. A lower surface of the light transmission board 120 is assembled with the printed circuit board 110. Here, the light transmission board 120 is referred to as a lower board in order to distinguish between the printed circuit board 110 and the light transmission board 120. The optical modulator 130 is assembled with an upper surface of the light transmission board 120 in correspondence with a hole formed on the printed circuit board 110. Here, the light transmission board 120 can be wholly made of a transparent material (e.g. glass) or can have a transparent area for light incident to the optical modulator 130. Alternatively, the light transmission board 120 can be formed with a hole on an area for the light incident to the optical modulator 130, in order to allow the incident light and modulated light to be penetrated.

In accordance with another embodiment of the present invention, the printed circuit board 110 is placed above the optical modulator 130. In other words, in order to receive an outside input signal inputted through the connector, the printed circuit board 110 can be placed above the optical modulator 130 and the driver IC 140a through 140d facing the lower board, which is the light transmission board 120, to perform a signal connection function with an external circuit. Circuits formed on the printed circuit board 110 and the light transmission board 120 can be connected with each other by wire-bonding or tape automated bonding. In case that the printed circuit board 110 is connected with the light transmission board 120 by the wire-bonding, a wire allowing the printed circuit board 110 and the light transmission board 120 to be connected with each other can be passivated by an epoxy resin. The below description is concentrated on the case that the printed circuit board 110 is placed below the light transmission board 120.

The optical modulator 130 emits modulated light by modulating the incident light through the hole formed on the printed circuit board 110. The optical modulator 130 can be contacted to the light transmission board 120 by flip-chip bonding. The optical modulator 130 is attached on the light transmission board 120 because a bonding material is formed around the optical modulator 130, and the electrical contact is maintained by an electrical wire formed along the surface of the light transmission board 120.

The driver IC 140a through 140d are contacted around the optical modulator 130, attached on the light transmission board 120, by flip-chip bonding. The driver IC 140a through 140d supply a driving voltage to the optical modulator 130 according to a control signal inputted from an outside.

The heat spreader 150, which is made of a metal-like material discharging heat well, is equipped in order to discharge heat, generated in the driver IC 140a through 140b.

The method of manufacturing the optical module package 100, illustrated in FIG. 2A, includes steps of assembling the connector 160 with the printed circuit board 110, assembling the optical modulator 130 and the driver IC 140a through 140d with the light transmission board 120, applying the bonding material around the optical modulator 130 and sealing them, laminating the light transmission board 120 on the printed circuit board 110 and performing a wire-bonding, and assembling the heat spreader 150 with the optical modulator 130 and the driver IC 140a through 140d.

Here, the light transmission board 120 can include a noise removing member intercepting a beam of light that is not incident to the micro-mirror of the light modulator 130. Here, the noise removing member can be realized as a bending member, emitting some of light incident to the optical modulator 130 in a different direction from modulated beams of light, a light absorbing member, absorbing a beam, which is not incident to the optical modulator 130, of the incident beams of light or roughness, reflecting a beam, which is not incident to the light transmission board 120, of the beams of light incident to a surface of the light transmission board 120 in a different direction from the modulated beams of light.

In other words, the bending member can remove the noise of modulated light corresponding to an image signal by diffusedly reflecting a beam of light, which is not incident to a mirror area of the optical modulator 130, of the incident light. The light absorbing member can basically remove the noise of the modulated light by absorbing the beam of light, which is not incident to the mirror area of the optical modulator 130, of the incident light. Here, the bending member can be made of a separate material, having a shape, in the light transmission board 120. Forming the roughness on a surface of the light transmission board 120 can cause the beam of light, which is not incident to the light transmission board 120, of the incident light to be diffusedly reflected.

Also, the bending member, the light absorbing member, or the roughness can be formed on a surface of the light transmission board 120, whereas they can be formed on a surface of the light transmission board 120, where the optical modulator 130 is located, or on a different surface from the surface of the light transmission board 120, where the optical modulator 130 is located. In the case of being formed on the surface of the light transmission board 120, where the optical modulator 130 is located, the bending member, the light absorbing member, the roughness are formed between the optical modulator 130 and the light transmission board 120. If the bending member, the light absorbing member, the roughness can remove the noise of the modulated light by performing the diffused reflecting function or the light absorbing function, the present invention is not limited to the position of the bending member, the light absorbing member, or the roughness.

FIG. 2B is a schematic view of a mobile display apparatus using an optical modulator and a scanner in accordance with an embodiment of the present invention. The below description is concentrated on a piezoelectric diffractive optical modulator. Referring to 2B, a light source 205, an optical modulator 210, a driving signal controlling unit 220, a polygon mirror 230, which is a scanner, and a screen 240.

The optical modulator 210 reflects, interferes and diffracts a laser beam emitted from the light source 205, corresponding to an image signal. Here, the modulator 210 emits modulated light in a vertical direction substantially at the same time (i.e. within a predetermined period of time). Such the modulated light realizes a two-dimensional image by the rotating polygon mirror 230. In the optical modulator 210 of the present invention, the number of ribbons is determined depending on pixels of a projector. Typically, in the case of a VGA resolution of 640*480, 480 ribbons are arranged such that the modulated light for vertical pixels can be reflected and diffracted to be scanned on the screen 240.

The driving signal controlling unit 220 receives a time value for a beam scanning inputted from a sensing device (not shown) and controls the diffractive optical modulator 210 and the polygon mirror 230. Here, the driving signal controlling unit 220 synchronizes a polygon mirror rotating signal with an image synchronizing signal such that a beam of light emitted from the optical modulator can be reflected in a predetermined area of the polygon mirror 230. Here, a scanning driver (not shown) can control the polygon mirror through the polygon mirror controlling signal.

Here, a lens (not shown) is placed between the optical modulator 210 and the polygon mirror 230 and concentrates modulated light, generated from the optical modulator 210, in a direction of a rotation axis of the polygon mirror 230.

The image synchronizing signal informs the start of a new frame and the start of a new scanning line in a frame. The start of the new frame is controlled by the vertical synchronizing signal, and the start of the new scanning line is controlled by the horizontal synchronizing signal. Since the optical modulator 210 of the present invention is formed with a ribbon at a constant position in a vertical direction, the optical modulator 210 of the present invention needs to be synchronized in the horizontal direction.

The polygon mirror 230 is turned on or off depending on driving control of the driving signal controlling signal. When operated, the polygon mirror 230 is constantly rotated at a predetermined speed. The polygon mirror 230 is realized as having a polygonal shape so as to reflect an incident beam of light through each side when rotating. At this time, the beam of light reflected from a side of the polygon mirror 230 forms a spot arrangement at regular intervals by scanning and scanned to the screen 240, whereas this spot arrangement generates one picture of the screen 240. For example, in the case of an image having a VGA resolution of 640*480, modulation is performed 640 times for one surface of the optical scanning device for 480 vertical pixels, to thereby generate 1 frame of display per surface of the optical scanning device.

The polygon mirror 230 is equipped with a motor (not shown) capable of rotating in two directions (e.g. clockwise and counterclockwise). The polygon mirror 230, which is being rotated by the motor, reflects a beam of light, scanned through a lens, in the direction toward the screen 240. Here, the optical scanning device can be a polygon mirror, a rotating bar, or a Galvano mirror, for example.

The above description is related to the perspective and plan views generally illustrating the optical modulator. Described below are certain embodiments of an optical modulator module package in accordance with the present invention. Hereinafter, the certain embodiments of the present invention, which are roughly divided into 4 embodiments, will be described in order. It is obvious that the present invention is not limited to these embodiments.

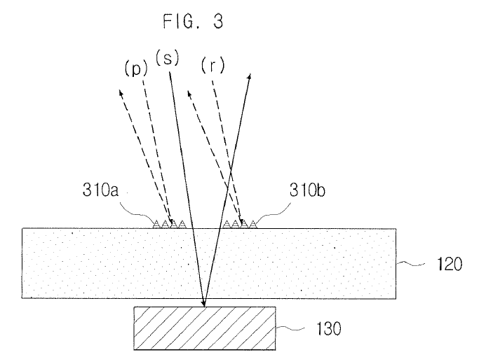

FIG. 3 illustrates a light path of an optical modulator package in accordance with a first embodiment of the present invention. Referring to FIG. 3, the light transmission board 120, the optical modulator 130 and bending members 310a and 310b are illustrated. The optical modulator 130 can be contacted to the light transmission board 120 by flip-chip bonding. However, the below description omits to illustrate these kinds of contacts and surrounding devices (e.g. driver IC) and focuses on a light path through which an incident beam of light and a modulated beam of light advance.

The light s incident from the light source to the optical modulator is modulated through being reflected and diffracted according to an image signal, and the modulated light is emitted to the foregoing scanner. However, the light p and r (i.e. some of the incident light), which is emitted from the light source but is not incident to the optical modulator 130, is diffusedly reflected in the bending members 310a and 310b provided in a surface of the light transmission board 120 before advancing in a different direction from the modulated light. Here, the bending members 310a and 310b are formed in a different surface from the surface of the light transmission board 120, which is coupled to the optical modulator 130.

The bending members 310a and 310b can be realized as having any shape capable of reflecting or diffusedly reflecting the incident light p and r in a direction different from the modulated light. For example, the bending members 310a and 310b, as illustrated FIG. 3, can be made of a plurality of reflecting materials having triangle-shaped sections. Here, the reflecting material has high reflectance, which reflects the light. For example, the reflecting material can be made of silver.

Alternatively, the bending members 310a and 310b can be a film formed with a plurality of reflecting materials, having triangle-shaped sections, in a surface of the film. Such the film is applied to the light transmission board 120, to thereby diffusedly reflect the incident light.

In case that there is provided no the bending members 310a and 310b in accordance with the related art, the incident light p and r is reflected in the light transmission board 120 and advances in the same direction as the modulated light. This may cause the noise to occur in the modulated light. However, in case that the bending members 310a and 310b are provided on the light transmission board 120, the incident light p and r is reflected in the bending member 310a and 310b and advances in a different direction from the modulated light or is diffusedly reflected. This may cause no noise to occur in the modulated light.

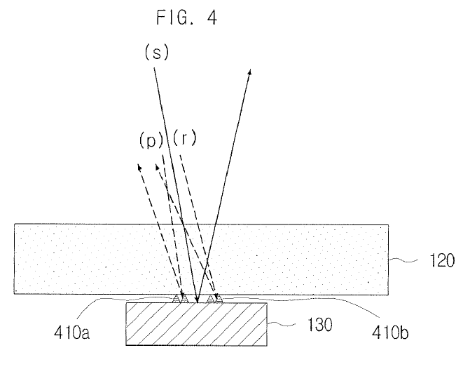

FIG. 4 illustrates a light path of an optical modulator package in accordance with a second embodiment of the present invention. Referring to FIG. 4, the light transmission board 120, the optical modulator 130 and bending members 410a and 410b are illustrated. The below description focuses on the difference between the aforementioned first embodiment and the second embodiment.

The bending members 410a and 410b can be formed on the surface of the light transmission board 120, which is coupled to the optical modulator 130, or on the optical modulator 130. In other words, the incident light s is reflected in the micro-mirror formed with the optical modulator 130, and the other light p and r is reflected in the bending members 410a and 410b and advances in a different direction from the modulated light or is diffusedly reflected.

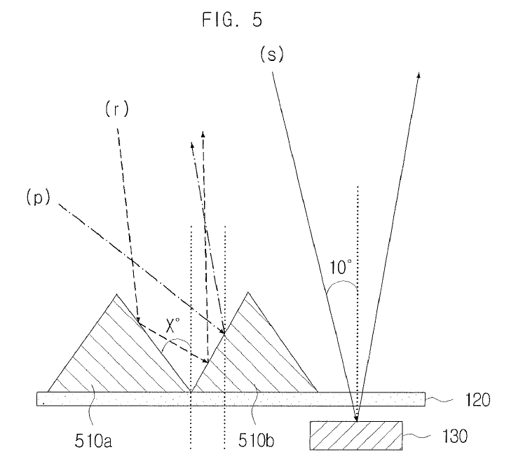

Accordingly, in the first embodiment, the incident light p and r reflected in the different surface from the surface of the light transmission board 120, which is connected with the optical modulator 130, is reflected in the bending member 310a and 310b, to thereby cause no noise to occur in the modulated light. However, in the second embodiment, the incident light p and r reflected in the optical modulator 130 is reflected in the bending member 410a and 410b, to thereby cause no noise to occur in the modulated light. FIG. 5 illustrates a structure of diffused reflection of an optical modulator package in accordance with a first embodiment of the present invention. Referring to FIG. 5, the light transmission board 120, the optical modulator 130 and bending members 510a and 510b.

The bending members 510a and 510b, which are formed of a plurality of reflecting materials having triangle-shaped sections, are able to be placed at a certain angle such that the light p and r, not incident to the optical modulator 130, can be reflected in a different direction from an advancing direction of the light s, incident to the optical modulator 130 and modulated. In other words, an angle x, which is formed by a line, different from a line tangent to the light transmission board 120, of the triangle-shaped sections of the plurality of reflecting materials and a normal line of the light transmission board 120, can be provided. For example, in case that the angle formed with the incident light s and the normal line of the light transmission board 120 is 10 degree, if the angle x is in a predetermined range, the light p and r, not incident to the optical modulator 130, can be reflected in a different direction from an advancing direction of the modulated light.

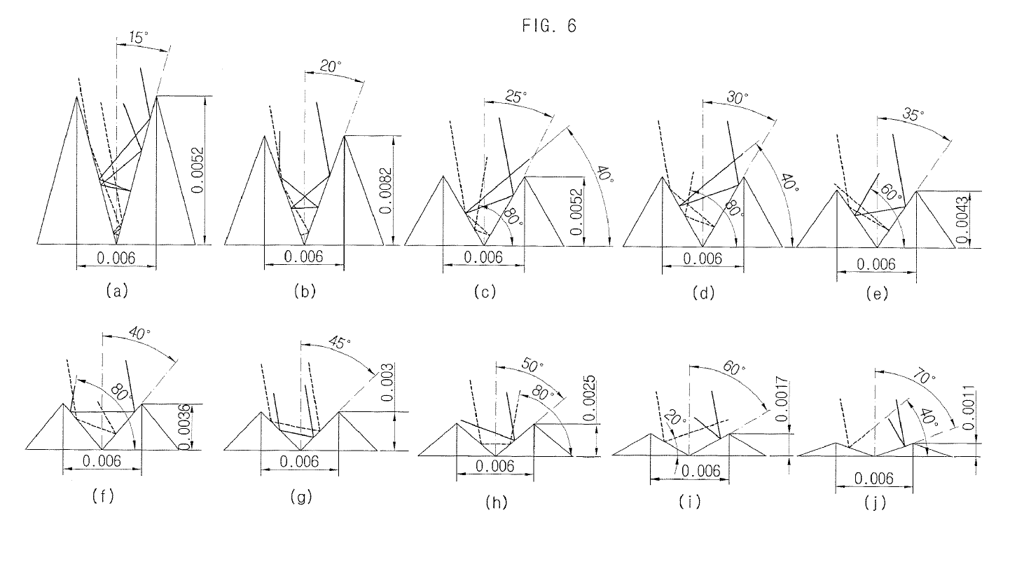

FIG. 6 illustrates an example for determining the angle x. The description of FIG. 6 assumes the cases a through j that the angle x, which is formed by a line, different from a line tangent to the light transmission board 120, of the triangle-shaped sections of the plurality of reflecting materials and a normal line of the light transmission board 120 is between 15 and 70 degree. Each numerical unit is millimeter.

Referring to FIGS. 6(a), (b), (f) and (g), most of the light, incident to the triangle-shaped sections of the plurality of reflecting materials is reflected in the same direction as the incident direction. Otherwise, the incident light mixed with the modulated light may be reflected, to thereby cause the noise to be generated. If the angle x, which is formed by a line, different from a line tangent to the light transmission board 120, of the triangle-shaped sections of the plurality of reflecting materials and a normal line of the light transmission board 120 is between 0 and 45 degree, the noise can be efficiently removed in accordance with the present invention. Of course, if the bending members 510a and 510b has another shape (e.g. trapezoid or circle), a valid angel capable of removing the noise can be determined. It shall be obvious that the present invention is limited to the shapes and angles.

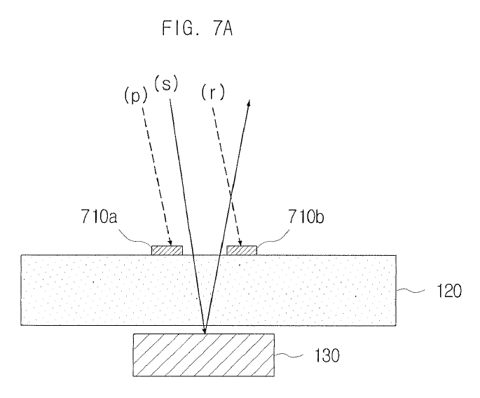

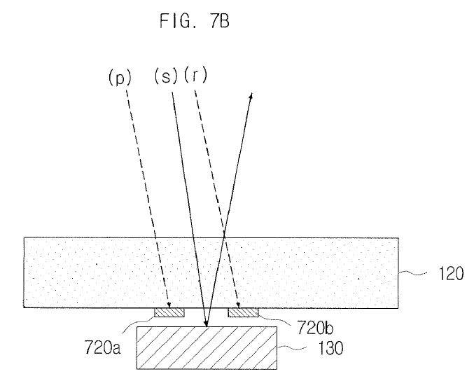

FIG. 7A and FIG. 7B illustrate a light path of an optical modulator package in accordance with a third embodiment of the present invention. Referring to FIG. 7A, the light transmission board 120, the optical modulator 130 and light absorbing members 710a and 710b are illustrated. Referring to FIG. 7B, the light transmission board 120, the optical modulator 130 and light absorbing members 720a and 720b are illustrated. The below description focuses on the difference between the aforementioned first embodiment and the third embodiment.

The light p and r (i.e. some of the incident light), which is emitted from the light source but is not incident to the optical modulator 130, is absorbed by the light absorbing members 710a and 710b, provided in a surface of the light transmission board 120. Accordingly, the light p and r, not incident to a mirror area of the optical modulator 130, excluding the light s incident from the light source to the mirror area of the optical modulator 130, is absorbed by the light absorbing members 710a and 710b, to thereby cause no noise to occur in the modulated light. Here, the light absorbing members 710a and 710b can be made of chrome or chrome oxide, which has low reflectance and transmission and high absorptance.

The light absorbing members 710a and 710b are formed on the surface (refer to FIG. 7B) of the light transmission board 120, which is coupled to the optical modulator 130, or on a different surface (refer to FIG. 7A) from the surface of the light transmission board 120 which is coupled to the optical modulator 130. In case that the light absorbing members 710a and 710b are formed on the surface of the light transmission board 120, which is coupled to the optical modulator 130, the light p and r incident to the surface causes no noise to occur in the optical modulator 130. Similarly, in case that the light absorbing members 710a and 710b are formed on a different surface from the surface of the light transmission board 120, which is coupled to the optical modulator 130, the light p and r incident to the different surface causes no noise to occur in the optical modulator 130.

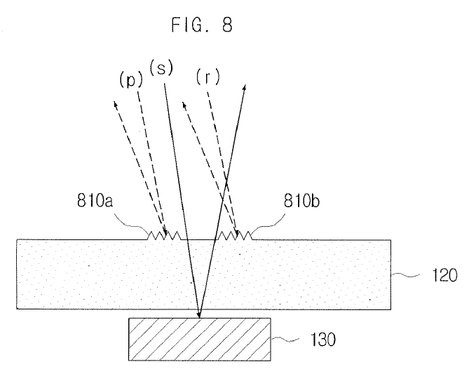

FIG. 8 illustrates a light path of an optical modulator package in accordance with a fourth embodiment of the present invention. Referring to FIG. 8, the light transmission board 120, the optical modulator 130 and roughness 810a and 810b are illustrated. The below description focuses on the difference between the aforementioned first embodiment and the fourth embodiment.

The roughness 810a and 810b can be formed on the light transmission board 120 by various methods. For example, the roughness 810a and 810b can be formed on the light transmission board 120 by a sanding process. Here, the sanding process can be performed by applying a sand bit or a glass bit to a surface of the light transmission board 120 and forming the roughness 810a and 810b.

Alternatively, the roughness 810a and 810b can be formed to have a predetermined pattern by coating a metal on the light transmission board 120 and aching the light transmission board 120 coated with the metal.

Although some embodiments of the present invention have been described, anyone of ordinary skill in the art to which the invention pertains should be able to understand that a very large number of permutations are possible without departing the spirit and scope of the present invention and its equivalents, which shall only be defined by the claims appended below.

What is claimed is:

1. An optical modulator module package, comprising:
an optical modulator, emitting a beam of light, which is modulated by diffracting and interfering the beam of light by an upwardly and downwardly spaced distance of a mirror, the beam of light being incident from a light source;
a driver IC, mounted on the surrounding of the optical modulator to drive the optical modulator; and
a noise removing member, intercepting a beam of light, which is not incident to a mirror area of the light modulator, of the incident beams of light.

2. The optical modulator module package of claim 1, wherein the noise removing member is a material, absorbing the beam of light, which is not incident to the mirror area of the light modulator, of the incident beams of light.

3. The optical modulator module package of claim 1, wherein the noise removing member is configured to diffusedly reflect the beam of light, which is not incident to the mirror area of the light modulator, of the incident beams of light.

4. An optical modulator module package, comprising:
a lower board, on which a circuit line is formed;
an optical modulator, located in a surface of the lower board and modulating an incident beam of light and penetrating the modulated beam of light through the lower board;
a driver IC, mounted on the surrounding of the optical modulator to receive a signal for driving the optical modulator through the circuit line formed on the lower board and to drive the optical modulator; and
a bending member, formed on the lower board and reflecting some of the incident beams of light in a different direction from an advancing direction of the modulated beams of light.

5. The optical modulator module package of claim 4, further comprising a printed circuit board, located on the optical modulator and the driver IC, facing the lower board, and performing a signal connecting function with an external circuit.

6. The optical modulator module package of claim 4, wherein the lower board comprises a transparent area, corresponding to the optical modulator, capable of light penetration.

7. The optical modulator module package of claim 4, wherein the bending member is made of a plurality of reflecting materials having triangle-shaped sections.

8. The optical modulator module package of claim 4, wherein the angle, which is formed by a line, different from a line tangent to the lower board, of the triangle-shaped sections of the plurality of reflecting materials and a normal line of the lower board is between 0 and 45 degree.

9. The optical modulator module package of claim 4, wherein the bending member is formed on a surface of the lower board, in which the optical modulator is located, or on another surface.

10. The optical modulator module package of claim 4, wherein the bending member is a film, a surface of which a plurality of reflecting materials, having triangle-shaped sections, is formed on.

11. An optical modulator module package, comprising:
a lower board, on which a circuit line is formed;
an optical modulator, located in a surface of the lower board and modulating an incident beam of light and penetrating the modulated beam of light through the lower board;
a driver IC, mounted on the surrounding of the optical modulator to receive a signal for driving the optical modulator through the circuit line formed on the lower board and drive the optical modulator; and
a light absorbing member, formed on the lower board and absorbing a beam of light, which is not incident to the light modulator, of the incident beams of light.

12. The optical modulator module package of claim 11, wherein the light absorbing member is made of chrome or chrome oxide.

13. The optical modulator module package of claim 11, further comprising a printed circuit board, located on the optical modulator and the driver IC, facing the lower board, and performing a signal connecting function with an external circuit.

14. The optical modulator module package of claim 11, wherein the lower board comprises a transparent area, corresponding to the optical modulator, capable of light penetration.

15. The optical modulator module package of claim 11, wherein the bending member is formed on a surface of the lower board, in which the optical modulator is located, or on another surface.

16. An optical modulator module package, comprising:
a lower board, on which a circuit line is formed;
an optical modulator, located in a surface of the lower board and modulating an incident beam of light and penetrating the modulated beam of light through the lower board; and
a driver IC, mounted on the surrounding of the optical modulator to receive a signal for driving the optical modulator through the circuit line formed on the lower board and drive the optical modulator,
whereas a roughness, reflecting a beam of light, which is not incident to the light modulator, of the incident beams of light in a different direction from an advancing direction of the modulated beam of light, is formed on a surface of the lower board.

17. The optical modulator module package of claim 16, wherein the roughness is formed by a sanding process.

18. The optical modulator module package of claim 16, wherein the roughness is formed by laser-etching a metal coated on the lower board.

19. The optical modulator module package of claim 16, further comprising a printed circuit board, located on the optical modulator and the driver IC, facing the lower board, and performing a signal connecting function with an external circuit.

20. The optical modulator module package of claim 16, wherein the lower board comprises a transparent area, corresponding to the optical modulator, capable of light penetration.
